(19) United States
(12) Patent Application Publication
(10) Pub. No.: US 2020/0082392 A1
(43) Pub. Date: Mar. 12, 2020

(54) GEOLOCATION-BASED PAYMENT PLATFORMS FOR RIDE-SHARING TRANSPORTATION

(71) Applicants: Shervin Pishevar, Miami Beach, FL (US); Keith Siilats, New York, NY (US)

(72) Inventors: Shervin Pishevar, Miami Beach, FL (US); Keith Siilats, New York, NY (US)

(21) Appl. No.: 16/128,036

(22) Filed: Sep. 11, 2018

(51) Int. Cl. G06Q 20/38; G06Q 30/02; G01C 21/34

(52) U.S. Cl. CPC G06Q 20/385; G01C 21/3438; G06Q 30/0238

(57) ABSTRACT

Transportation sharing based payment systems and methods are described herein. An example system includes a processor configured to ascertain a current user of a transportation asset and routing information of the transportation asset. The processor may link a funding source of the current user to a payment platform and direct the current user to a merchant location based on the routing information by using an incentive to purchase an item at the merchant location. The processor may further determine that the transportation asset has arrived at the merchant location and upon receipt of an indication from the current user of an intent to purchase the item associated with the incentive, complete a financial transaction associated with a purchase of the at least one item. The financial transaction may be completed directly through the payment platform without the use of the funding source.

### TECHNICAL FIELD

The present disclosure relates generally to data processing and, more particularly, to geolocation-based transportation sharing, visualization of availability of ride-share assets, and arranging of transportation means.

### BACKGROUND

Conventional payment systems using credit cards may be inconvenient for various reasons. For example, if a customer wants to buy a product, the act of taking out a credit card and swiping or touching a payment terminal with the credit card may take longer than simply picking up the product from a product stand, such as, for example, a food stand selling prepared sandwiches. Additionally, attracting customers to the product stand in order for them to buy a product may be challenging because the customers do not want to spend the time to pay for the product with a credit card. Therefore, the conventional payment systems provide no reliable solutions for “on the fly” payments that would enable customers to save time on providing payment information.

A variety of solutions have been proposed to capture payment information faster. For example, wearables such as armbands with embedded payment chips as well as implanted chips have been introduced. However, batteries in these devices are not powerful enough to transmit payment information other than for very short distances. In some other conventional payment systems, a smartphone can operate as a payment token. A merchant may push notifications concerning an offer to a smartphone based on location data of the smartphone and allow the customer to claim the offer. However, a smartphone can be stolen and, thus, is not secure enough for automatic payments without additional authentication of the customer with, for example, a fingerprint.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer-implemented transportation sharing based payment systems and methods. In some example embodiments, a transportation sharing based payment system may include a processor and a database communicatively coupled to the processor and storing instructions executable by the processor. The processor may be configured to ascertain a current user of a transportation asset and routing information associated with the transportation asset and the current user. The processor may be further configured to link a funding source of the current user to a payment platform. The processor may be further configured to direct the current user to a merchant location based on the routing information by using an incentive to purchase at least one item at the merchant location.

The processor may be configured to determine that the transportation asset has arrived at the merchant location. The processor may be further configured to receive an indication from the current user of an intent to purchase the at least one item associated with the incentive. The processor may be configured to complete a financial transaction associated with a purchase of the at least one item. The financial transaction may be completed based at least on the indication of the intent to purchase and determination that the transportation asset has arrived at the merchant location. The financial transaction may also be completed directly through the payment platform without the use of the funding source.

In some example embodiments, systems and methods for visualizing availability of ride-share transportation assets are provided. In some example embodiments, a system for visualizing availability of ride-share transportation assets may include a processor and a database communicatively coupled to the processor and storing instructions executable by the processor. The processor may be configured to receive, from a user, a desired pick-up location for a ride-share transportation asset associated with a ride-share network. The processor may be further configured to automatically calculate a range of acceptable pick-up locations in a vicinity of the desired pick-up location. The processor may be configured to ascertain routing information concerning a plurality of ride-share transportation assets. The plurality of ride-share transportation assets may be associated with the ride-share network.

The processor may be configured to predict availability times and destinations for the plurality of ride-share transportation assets based on the routing information. The processor may be configured to visualize, via a user device associated with the user, arrival information for the plurality of ride-share transportation assets. The arrival information may be visualized for each of the plurality of ride-share transportation assets with a predicted destination within the vicinity of the desired pick-up location at the predicted availability time. The visualization may be indicative of an arrival time for each of the plurality of ride-share transportation assets in the vicinity of the desired pick-up location.

In some example embodiments, systems and methods for arranging transportation means are provided. In some example embodiments, a system for arranging transportation means may include a processor and a database communicatively coupled to the processor and storing instructions executable by the processor. The processor may be configured to receive a service request from a user device associated with a user. The service request may include a current location of the user device, a destination location, and vehicle criteria. The vehicle criteria may include a combination of a car and an electric mobility device. The processor may be configured to determine current locations of a plurality of vehicles available to provide the transportation means.

The processor may be further configured to select, from the plurality of vehicles, a vehicle based at least on the current location of the user device and the current locations of the plurality of vehicles. The plurality of vehicles may satisfy the vehicle criteria. The processor may be further configured to automatically calculate an optimal route from the current location of the user device to the destination location. The optimal route may include a vehicle change point. The vehicle change point may be a point along the optimal route where the electric mobility device is removed from the car and used by the user for the remainder of the optimal route. The processor may be further configured to determine a fare for providing the transportation means to the customer. The fare may be based on the current location of the user device, the destination location, and the vehicle change point.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and, in which:

FIG. 1 illustrates an environment within which transportation sharing based payment systems and methods can be implemented, in accordance with some embodiments.

FIG. 2 is a block diagram showing various modules of a transportation sharing based payment system, in accordance with certain embodiments.

FIG. 3 is a flow chart illustrating a transportation sharing based payment method, in accordance with an example embodiment.

FIG. 4 illustrates an environment within which systems and methods for visualizing availability of ride-share transportation assets can be implemented, in accordance with some embodiments.

FIG. 5 is a block diagram showing various modules of a system for visualizing availability of ride-share transportation assets, in accordance with certain embodiments.

FIG. 6 is a flow chart illustrating a method for visualizing availability of ride-share transportation assets, in accordance with an example embodiment.

FIG. 7 illustrates an environment within which systems and methods for arranging transportation means can be implemented, in accordance with some embodiments.

FIG. 8 is a block diagram showing various modules of a system for arranging transportation means, in accordance with certain embodiments.

FIG. 9 is a flow chart illustrating a method for arranging transportation means, in accordance with an example embodiment.

FIG. 10 shows a computing system that can be used to implement transportation sharing based payment methods, methods for visualizing availability of ride-share transportation assets, and methods for arranging transportation means, according to an example embodiment.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides transportation based payment systems and methods. A transportation based payment system can enable a user to link a credit card to a shared transportation asset, such as a shared car, a shared bicycle, a shared scooter, and the like. Specifically, the system can allow a user to rent a ride sharing transportation asset, e.g., via an application running on a user device. The system may then authenticate the user, for example, by using a fingerprint of the user, and request that the user provides payment data. The system may then prompt the user to link a payment method, such as a credit card, to the transportation asset. The payment data provided by the user may be used by the system for payments related to renting the transportation asset and for payments made at various merchant locations.

The transportation asset may include a controller and a wireless communication chip. The user may provide credit card data to the wireless communication chip of the transportation asset. The wireless communication chip may generate a one-time use token based on the credit card data. Because a covert theft of the transportation asset is unlikely, the transportation asset may be secure enough to generate a next one-time use token automatically without further requesting any authentication data from the user, such as a fingerprint for example.

The system may determine routing information of the user, for example, based on a source location and a destination location selected by the user upon sending a request to rent the transportation asset. The system may use the routing information to direct the user to one or more merchant locations along a route of the user. For example, the system may provide incentives to the user device to purchase products at a merchant location. The user may accept an offer provided in the incentive and, in response, the system may select a route to the merchant location. The merchant location may be on the route of the user or within a vicinity of the route. Additionally, the system may determine an estimated time of arrival of the transportation asset at the merchant location. Based on the determination, the merchant may make a product associated with the offer, for example, a coffee, a burger, a pizza available at the time of the arrival of the transportation asset with the user. Therefore, upon arrival at the merchant location, the user can receive the product without waiting for the product to be prepared.

A merchant associated with the merchant location may have a reader configured to read payment data from the transportation asset, for example, via a Bluetooth connection. The reader may be associated with a docking station for the transportation assets. Furthermore, the system may be configured to determine whether the user has arrived at the merchant location. For example, the system may compare the merchant location and a current location of the transportation asset based, for example, on a Global Positioning System (GPS) system of the transportation asset or a user device. If the current location of the transportation asset and the merchant location share the location or the current location of the transportation asset is in a close proximity of the merchant location, the system will determine that the user has arrived at the merchant location.

Upon determination that the user is at the merchant location and receiving an indication of user intent to purchase the product, the system may complete a financial transaction associated with a purchase of the product with the one-time use token. For example, the docking station located within a vicinity of the merchant location can read the one-time use token from the transportation asset of the user and send the one-time use token to the payment system. Upon receipt of the one-time use token from the merchant, the payment system may authorize the payment and transfer funds from the credit card of the user to a merchant account. Therefore, the financial transaction may be completed at the merchant location without the actual use of the credit card by the user.

After the ride is completed, the user may pay for renting the transportation asset with the token associated with the transportation asset. After the rent of the transportation asset is paid for, the token may be unlinked from the transportation asset. Therefore, the transportation asset may become unauthenticated and it would be no longer possible to charge the user for any products using the token. Additionally, the payment source of the user may be unlinked from the payment system.

The present disclosure further provides systems and methods for visualizing the availability of ride-share transportation assets. When users utilize a conventional shared transportation system that includes several available transportation assets, an application associated with the transportation system and running on the user device may display several available electric scooters for rent. However, the number of available scooters displayed by the application may be limited because some of the electric scooters may be currently in use. Since a typical electric scooter ride may be short, such as less than half an hour, there may be a plurality of scooters becoming available within the next few minutes. However, displaying all scooters, both available and occupied, may be not practical because such display would become cluttered, and privacy of users may be compromised. Additionally, some of the occupied electric scooters may not become available for a longer time so displaying them would not be useful. The conventional shared transportation systems typically ask users to provide a destination, but this may be inconvenient for users who want to rent a scooter with a single click function and to avoid typing the destination address.

The system for visualizing the availability of ride-share transportation assets of the present disclosure may use machine learning techniques to predict availability time and locations of transportation assets and display the availability times and locations to the user on the user device. Specifically, the system may receive a desired pick-up location from the user, determine routing information of a plurality of ride-share transportation assets, and apply machine learning techniques to predict availability times and locations for each ride-share transportation asset based on the routing information. Upon determination of the availability times and destinations of the ride-share transportation asset, the system may visualize, via a user device, arrival information for each of the ride-share transportation assets. The arrival information may include an arrival time for each of the of ride-share transportation assets in the vicinity of the desired pick-up location. Therefore, the user may select not only among the currently available ride-share transportation assets, but rather a ride-share transportation asset for a specific arrival time at the desired pick-up location.

The present disclosure further provides systems and methods for arranging transportation means. The user may send a request for a transportation means to the system, with the request including a current location of the user, destination location, and indication that the transportation means is a combination of a car and an electric mobility device. Upon receipt of the request from the user, the system may determine current locations of vehicles available to provide the transportation means. The system may further select one of the vehicles based on the current locations of the vehicles, current location of the user, and automatically calculate an optimal route from the current location of the user to the destination. As part of calculating the optimal route, the system may determine an optimal vehicle change point along the route. At the vehicle change point, the electric mobility device can be removed by the user from the vehicle and ridden by the user for the remainder of the optimal route. Thus, the user may ride the vehicle from the current location to the vehicle change point and then ride the electric mobility device removed from the vehicle from the vehicle change point to the destination. The system may determine a fare for the ride by the car and for the ride by the electric mobility device and charge the user based on the determined fare.

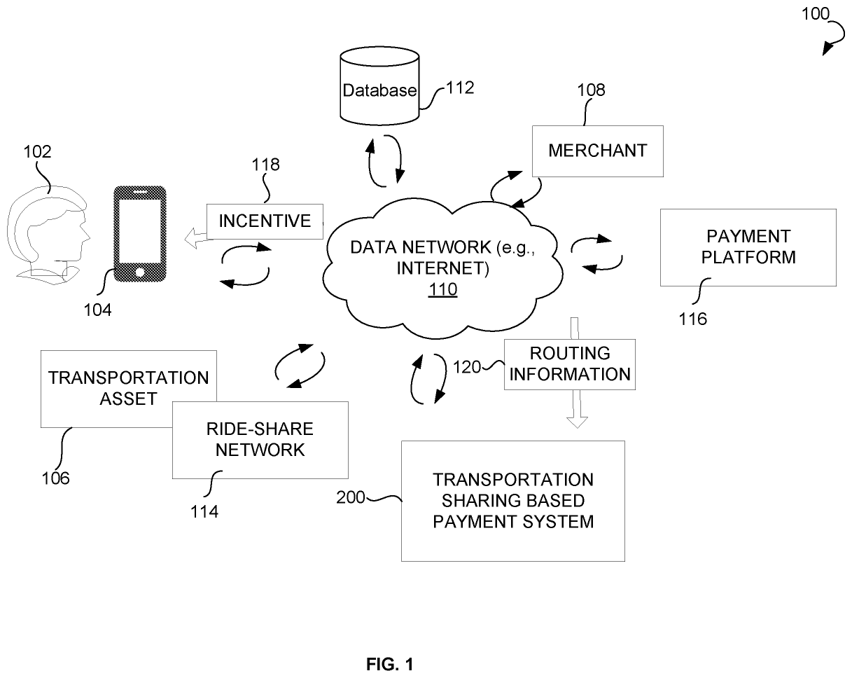

FIG. 1 illustrates an environment 100 within which transportation sharing based payment systems and methods can be implemented, in accordance with some embodiments. The environment 100 may include a user 102, a user device 104, a transportation sharing based payment system 200 (also referred to as a system 200), a ride-share network 114, a transportation asset 106 associated with the ride-share network 114, a merchant 108, a data network 110 (e.g., the Internet or a computing cloud), a payment platform 116, and a database 112. The user device 104, the system 200, the ride-share network 114, the transportation asset 106, the payment platform 116, and the merchant 108 may be connected via the data network 110. The user 102 may be associated with the user device 104. The user device 104 may include a smartphone, a laptop, a tablet PC, an Internet phone, a netbook, a smartwatch, smartglasses, and so forth.

The data network 110 may include a computing cloud, the Internet, or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

The ride-share network 114 may include a plurality of transportation assets, e.g., vehicles. The user 102 may select and rent one transportation asset of the ride-share network 114 using the user device 104. The system 200 may ascertain the user 102 of the transportation asset and request that the user 102 links a funding source, e.g., a credit card, of the user 102 to the payment platform 116. Based on payment data of the credit card of the user 102, the system 200 may issue a token, e.g., a one-time use token, associated with the payment data, and store the token in a wireless communication chip of the transportation asset 106. The system 200 may store the payment data to the database 112. In an example embodiment, the system 200 may provide the token to the user device 104 and the user device 104 may provide the token to the transportation asset 106.

The system 200 may further determine routing information 120 of the transportation asset 106 driven by the user 102. The system 200 may use the routing information 120 to select the merchant 108 that provides special offers and is located along a route of the user 102. Upon selection of the merchant 108, the system may send an incentive 118 to the user device 118 informing the user 102 about the special offers. When the system 200 determines that the transportation asset 106 is at a merchant location associated with the merchant 108, the system 200 may determine that the user intends to purchase a product provided in an offer and request the token from the transportation asset 106 located at the merchant location. In an example embodiment, the token may be read by a docking station located at the merchant location and transferred to the system 200. Upon receipt of the token, the system 200 may perform a financial transaction based on the payment data stored in the database 112 by the payment platform 116.

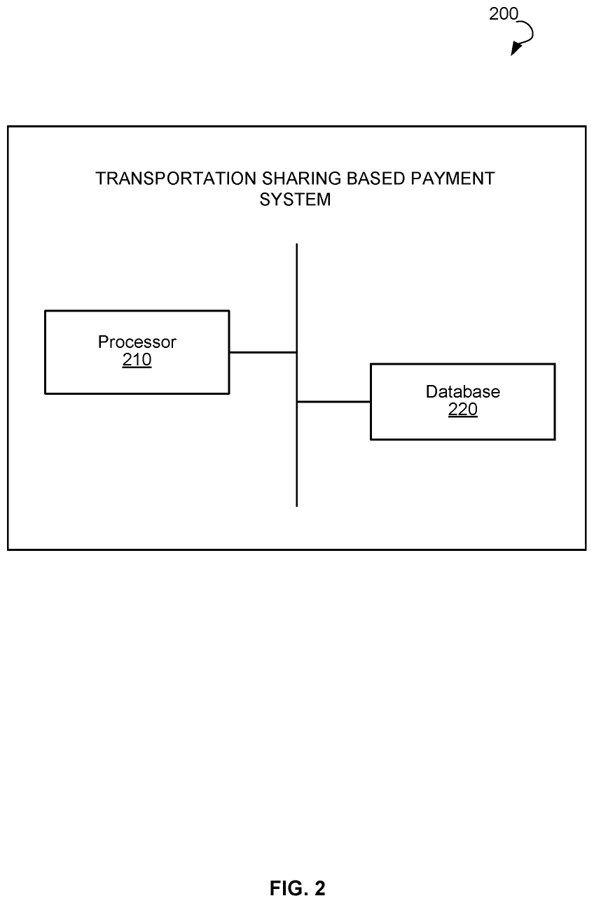

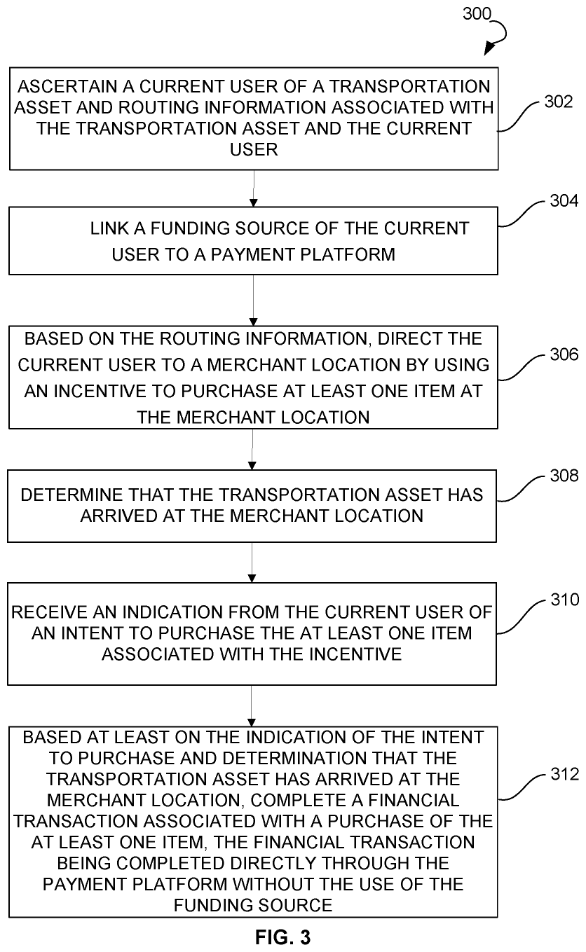

FIG. 2 is a block diagram showing various modules of a transportation sharing based payment system 200, in accordance with certain embodiments. The system 200 may include a processor 210 and a database 220. The database 220 may include computer-readable instructions for execution by the processor 210. The processor 210 may include a programmable processor, such as a microcontroller, central processing unit (CPU), and so forth. In other embodiments, the processor 210 may include an application-specific integrated circuit or programmable logic array, such as a field programmable gate array, designed to implement the functions performed by the system 200. In various embodiments, the system 200 may be installed on a user device or may be provided as a cloud service residing in a cloud storage. The operations performed by the processor 210 and the database 220 are described in detail with reference to FIG. 3.

FIG. 3 is a flow chart illustrating a transportation sharing based payment method 300, in accordance with an example embodiment. In some embodiments, the operations may be combined, performed in parallel, or performed in a different order. The method 300 may also include additional or fewer operations than those illustrated. The method 300 may be performed by processing logic that comprises hardware (e.g., decision making logic, dedicated logic, programmable logic, and microcode), software (such as software run on a general-purpose computer system or a dedicated machine), or a combination of both.

The method 300 may commence with ascertaining, by a processor, namely by the processor 210 shown on FIG. 2, a current user of a transportation asset and routing information associated with the transportation asset and the current user at operation 302. In an example embodiment, the transportation asset may include at least two vehicles. The current user may be able to use at least one of the vehicles for at least part of a travel to the merchant location. In a further example embodiment, the transportation asset may include one of the following vehicles: an electric scooter, a bicycle, an electric bicycle, a car, an electric motorbike, a self-balancing scooter, and the like. In an example embodiment, the electric scooter may be part of a fleet of peer-to-peer ridesharing electric scooters.

The routing information may include one or more of the following: a current location of the transportation asset, a current route of the transportation asset, historical routes of the current user, historical routes of a plurality of users, a predicted location of the transportation asset, a desired destination of the current user, and the like.

The method 300 may then continue with linking, by the processor, a funding source of the current user to a payment platform at operation 304. To link the funding source to the payment platform, the user may enter payment data, such as credit card data, via the user device. The payment data may be provided to the payment platform. The payment platform may generate a token based on the payment data and provide the token to the user device. The user device may transfer the token to the transportation asset. In an example embodiment, the transportation asset may include a controller and a wireless communication chip. The token may be stored on the wireless communication chip of the transportation asset. In an example embodiment, the payment platform may provide the token directly to the transportation asset.

The method 300 may further include directing, by the processor, at operation 306, the current user to a merchant location by using an incentive to purchase at least one item at the merchant location. The incentive may include one of the following: a discount, a special deal, a promotion, and the like. In an example embodiment, the incentive may be part of a plurality of incentives provided by a plurality of merchants. In another example embodiment, the incentive may be provided based on a determination that the merchant location is along a predicted route of the transportation asset. The current user may be directed to the merchant location based on the routing information.

The method 300 may further include operation 308, at which the processor determines that the transportation asset has arrived at the merchant location. The method 300 may further include receiving, by the processor, an indication from the current user of an intent to purchase the at least one item associated with the incentive at operation 310. In an example embodiment, the arrival of the transportation asset at the merchant location may be determined as an indication of the intent of the user to purchase the at least one item. In a further example embodiment, the user may provide the indication by showing the offer on the user device at the merchant location.

The method 300 may continue with completing, by the processor, a financial transaction associated with a purchase of the at least one item at operation 312. The financial transaction may be completed based at least on the indication of the intent to purchase and determination that the transportation asset has arrived at the merchant location. Furthermore, the financial transaction may be completed directly through the payment platform without the use of the funding source. Specifically, the user does not need to provide a physical credit card at the merchant location. The financial transaction may be completed using pre-stored payment information associated with the current user of the transportation asset. The user may store the payment information on the payment platform in advance, e.g., during the registration on the payment platform or the transportation sharing based payment system. The financial transaction may be processed using the controller and the wireless communication chip associated with the transportation asset.

In an example embodiment, the financial transaction may be completed by scanning a payment code associated with the incentive on a user device associated with the current user at the point of purchase associated with the merchant. The payment code may be generated and presented to the device of the current user upon arrival of the current user at the merchant location. For example, the payment code may include a QR code associated with the incentive and may pop up on the user device when the current user enters the merchant location. The financial transaction may be performed upon scanning of the payment code associated with the incentive by a reader of the merchant and based on the payment data determined based on a token read from the transportation asset by the docking station at the merchant location. In other words, the financial transaction may be completed by transmitting tokenized credit card information by the transportation asset to the merchant wirelessly via the docking station located within a vicinity of the merchant location.

In an example embodiment, the payment system may provide the token to the user device and, upon request of the transportation asset, the user device may provide the token to the transportation asset for transmitting the token to the docking station. The docking station may be in front of the merchant location. Therefore, when the user enters the merchant location, the token is already read by the docking station from the transportation asset and the user does not need to provide the token to the merchant location. In some embodiments, the user may need to verify a user name or a transportation asset identifier to the merchant inside the merchant location, for example, when tokens from several transportation assets that are currently at the merchant location are read by the docking station. In an example, embodiment, the user may provide the user name or the transportation asset identifier to the merchant verbally. The merchant may have a list of all transportation assets that are currently at the merchant location and the tokens of which are read by the docking station. The merchant may select, from the list, the user name or the transportation asset identifier provided by the user to the merchant.

In another example embodiment, the financial transaction may be performed automatically without scanning any payment code when it is determined that the user has arrived at the merchant location. Therefore, the user may not need to bring the user device inside the merchant location because the payment data of the user is already determined based on the token read from the transportation asset by the docking station located in a proximity of the merchant location.

In an example embodiment, the financial transaction may be completed automatically upon arrival of the transportation asset at the merchant location. Therefore, as the token is transmitted to the docking station by the transportation asset of the user, the user does not need to carry a credit card or a mobile phone with the credit card linked to the mobile phone. Additionally, in conventional solutions, for security reasons, the mobile phone receives a unique payment token associated with payment data of the credit card and does not receive the payment data of the credit card. After the unique payment token is used, a new unique payment token is generated upon additional authentication of the user (e.g., using fingerprints). In the system of the present disclosure, in case of transmitting the token by the transportation asset, the user does not need to be authenticated each time the new token is generated because the new token is generated automatically after each purchase during the period of renting the transportation asset.

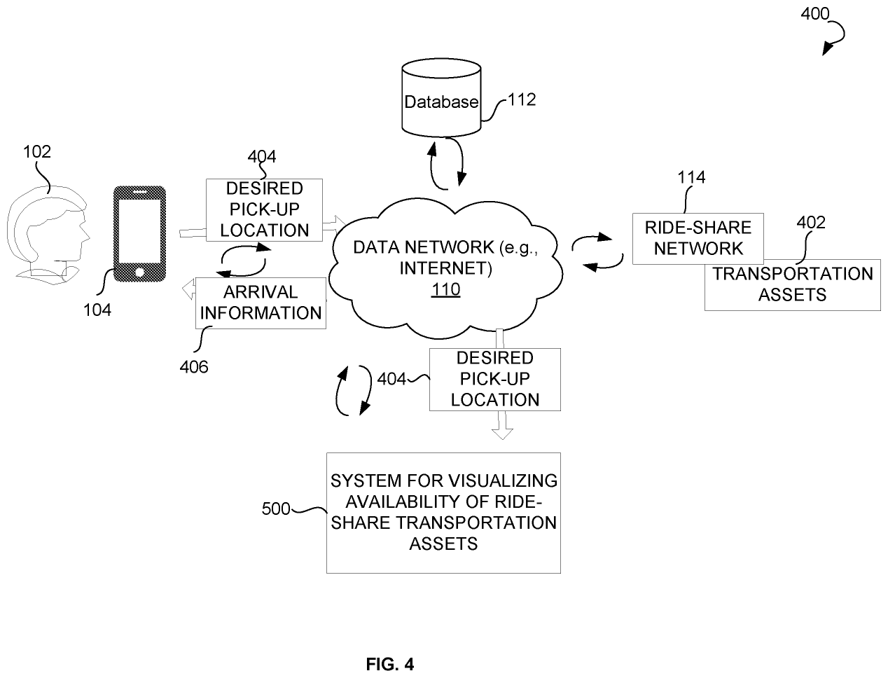

FIG. 4 illustrates an environment 400 within which systems and methods for visualizing availability of ride-share transportation assets can be implemented, in accordance with some embodiments. The environment 400 may include a user 102, a user device 104, a system 500 for visualizing availability of ride-share transportation assets (also referred to as a system 500), a ride-share network 114, transportation assets 402 associated with the ride-share network 114, a data network 110 (e.g., the Internet or a computing cloud), and a database 112. The user device 104, the system 500, the ride-share network 114, and the transportation assets 402 may be connected via the data network 110.

The ride-share network 114 may include a plurality of transportation assets 402, e.g., vehicles. The user 102 may sent a request, via the user device 104, to rent one of the transportation assets 402 of the ride-share network 114. The request may include at least a desired pick-up location 404 for the transportation asset. The system 500 may receive the desired pick-up location 404 of the transportation asset and based on the desired pick-up location 404, the system 500 may calculate a range of acceptable pick-up locations in a vicinity of the desired pick-up location 404 and determine routing information concerning the transportation assets 402. Based on the routing information, the system 500 may predicts availability times and destinations for the transportation assets 402. In an example embodiment, an estimate of probabilities of the predicted destination may be performed by making predictive assumptions. Based on the predicted destinations within the vicinity of the desired pick-up location 404 at the predicted availability time, the system 500 may visualize arrival information 406 for the plurality of ride-share transportation assets on the user device 104.

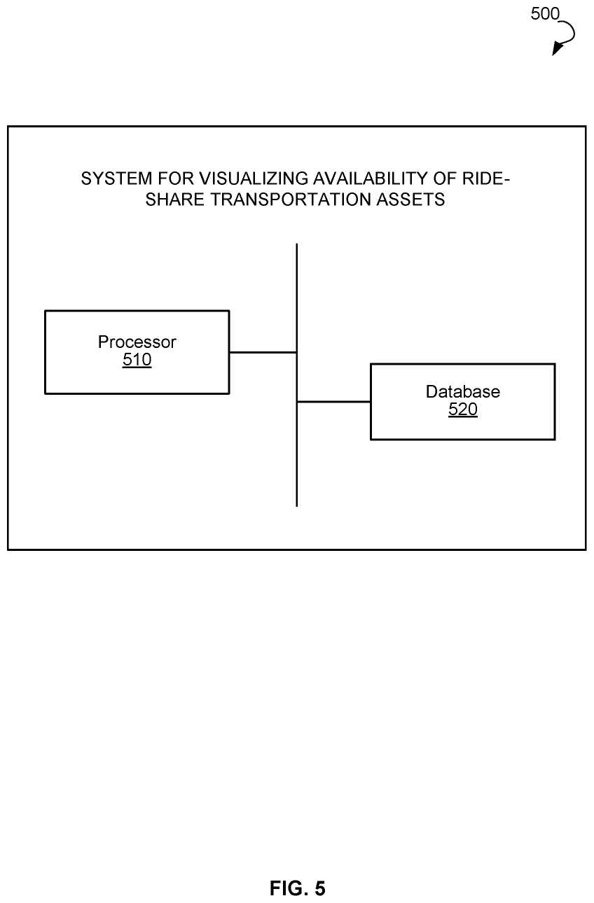

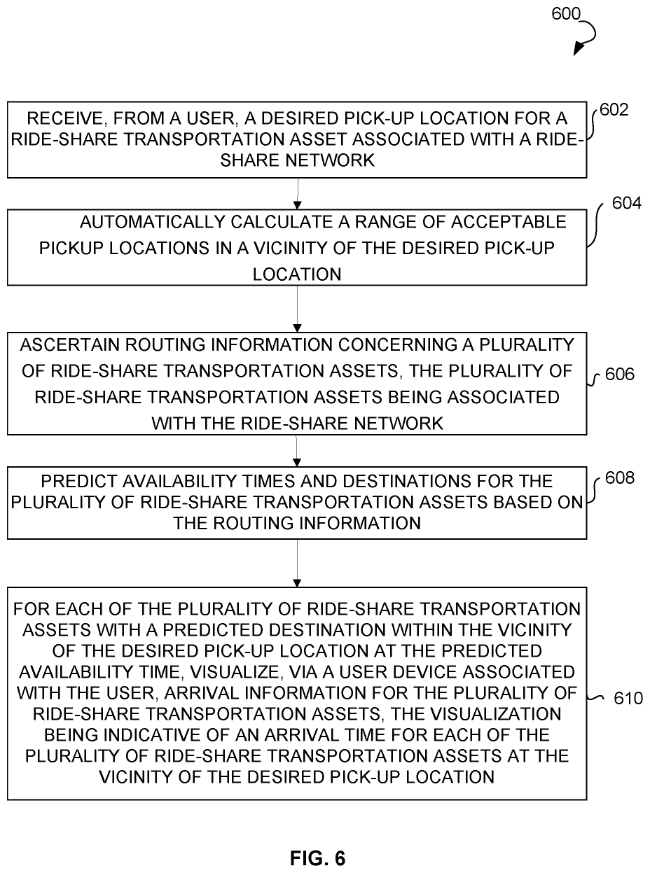

FIG. 5 is a block diagram showing various modules of a system 500 for visualizing availability of ride-share transportation assets, in accordance with certain embodiments. The system 500 may include a processor 510 and a database 520. The database 520 may include computer-readable instructions for execution by the processor 510. The processor 510 may include a programmable processor, such as a microcontroller, CPU, and so forth. In other embodiments, the processor 510 may include an application-specific integrated circuit or programmable logic array, such as a field programmable gate array, designed to implement the functions performed by the system 500. In various embodiments, the system 500 may be installed on a user device or may be provided as a cloud service residing in a cloud storage. The operations performed by the processor 510 and the database 520 are described in detail with reference to FIG. 6.

FIG. 6 is a flow chart illustrating a method 600 for visualizing availability of ride-share transportation assets, in accordance with an example embodiment. In some embodiments, the operations may be combined, performed in parallel, or performed in a different order. The method 600 may also include additional or fewer operations than those illustrated. The method 600 may be performed by processing logic that may comprise hardware (e.g., decision making logic, dedicated logic, programmable logic, and microcode), software (such as software run on a general-purpose computer system or a dedicated machine), or a combination of both.

The method 600 may commence with receiving, by a processor, namely by the processor 510 shown on FIG. 5, from a user, a desired pick-up location for a ride-share transportation asset associated with a ride-share network at operation 602. In an example embodiment, the ride-share transportation asset may include an electric scooter. The desired pick-up location may include a current location of the user or any location entered by the user on the user device or selected on a virtual map displayed on the user device.

The method 600 may further include automatically calculating at operation 604, by the processor, a range of acceptable pick-up locations in a vicinity of the desired pick-up location. The method 600 may continue with ascertaining, by the processor, routing information concerning a plurality of ride-share transportation assets at operation 606. The plurality of ride-share transportation assets may be associated with the ride-share network. In an example embodiment, the routing information may include one or more of the following: a current location, a travel direction, an intended route, destination, user attributes, historical travel data of the user using the device, historical travel data of a plurality of users that use the system for renting the transportation asset, and so forth. The historical travel data may include user riding data and locations frequented by the user, such as home, work, gym, and the like. In a further example embodiment, the routing information may be further based on aggregate locations of common public interest destinations. The common public interest destinations may include landmarks. Landmarks may include places frequently visited by the users as well as restaurants, public transport stations, railway stations, and the like.

Aggregate historic data associated with a plurality of users may be noisy and incomplete in new cities in which the system for visualizing availability of ride-share transportation assets is launched. However, the data associated with another city that has a plurality of users can be correlated to a database of landmark locations, and the obtained data may be applied in new cities. For example, a landmark, such as a police station may not be useful. For example, by looking at scooter rides in Miami for the past 6 months, it can be seen that few people take scooters to the police station. However, another landmark, such as a McDonald's restaurant, may be useful because it can be seen, based on the historic data, that scooters are often left at the McDonald's restaurant. Therefore, when a ride-share network provider is launched in a new city, such as, for example, Washington, DC, the ride-share network provider may predict that McDonald's restaurants are going to be popular destinations based on user behavior observed in Miami. Thus, when the system determines that a shared scooter is riding towards a McDonald's restaurant, the system can predict that the user of the scooter is likely to terminate the ride at the McDonald's restaurant, thereby allowing the next user to start the ride on the same scooter by picking it up near the McDonald's restaurant.

The historical travel data of users may include information that the user usually uses the system for riding from a first location to a second location. Therefore, if the desired pick-up location of the user is the first location, then the destination is likely the second location.

The historical travel data of the plurality of users may include information that one or more users usually arrive at a subway station about 9 am after leaving a street with a plurality of restaurants. Therefore, it may be predicted that a first user that has no recorded historic data who rented the transportation asset on the street having the plurality of restaurants earlier than 9 am will most likely ride to the subway station, even though the prediction for the first user based on this specific user historic data may be impossible. Therefore, if a second user exits the subway station at about 9 am, data concerning the transportation asset rented by the first user may be displayed to the second user because it is predicted by the system that the destination of the first user is the subway station.

The method 600 may further include predicting, by the processor, availability times and destinations for the plurality of ride-share transportation assets based on the routing information at operation 608. In an example embodiment, the prediction of the availability times of the plurality of ride-share transportation assets may be based on a current distance of each of the plurality of ride-share transportation assets to the desired pick-up location. Therefore, the user does not need to select the destination location when sending the request to rent the ride-share transportation asset. In an example embodiment, the prediction concerning the destinations of the plurality of ride-share transportation assets may be based on historical travel data of the users that are currently riding the plurality of ride-share transportation assets, historical travel data of a plurality of users that have used the system for renting the transportation asset in the past, and so forth

The method 600 may continue with visualizing, via a user device associated with the user, arrival information for the plurality of ride-share transportation assets at operation 610. The arrival information may be visualized for each of the plurality of ride-share transportation assets and may include a predicted destination of each of the plurality of ride-share transportation assets within the vicinity of the desired pick-up location and the predicted availability time at the predicted destination. Therefore, the visualization may be indicative of an arrival time for each of the plurality of ride-share transportation assets in the vicinity of the desired pick-up location.

For example, the visualization may include gradually changing colors of icons associated with the plurality of ride-share transportation assets to indicate a predicted time left to the availability of the plurality of ride-share transportation assets. In a further example embodiment, the visualization may include gradually changing colors of icons associated with an accuracy of the predicted destination. In another example embodiments, the visualization may include gradually changing colors of icons associated with the distance from the predicted destination to the desired pick-up location.

For example, a map shown on the user device may show available ride-share transportation assets as black pins, show ride-share transportation assets that will be available within the next 3 minutes with over 90% certainty or currently within a predetermined radius of the desired pick-up location as grey pins, and show ride-share transportation assets that will be available within the next 5 minutes with over 50% certainty as light grey pins.

In a further example embodiment, the system of the present disclosure may have access to a database of the capabilities of a plurality of ride sharing systems and may use the capabilities data to compute a combined route for the user. For example, for conventional ride sharing services, the user has several choices of ride sharing platforms to use. For example, a vehicle of a first ride sharing platform may be 5 minutes away, take 15 minutes to ride to a destination location, and cost $10, whereas a vehicle of the second sharing platform may be a 3 minute walk away, take 30 minutes to ride, and cost $8. However, in conventional ride sharing services, it is impossible to calculate a route that combines both the first ride sharing platform and the second ride sharing platform. The system of the present disclosure may select a combined route to the user to take the car of the first ride sharing platform on the highway for 10 minutes, and then use the bicycle of the second ride sharing platform for the last 5 minutes of the ride.

In another embodiment, once the system computes the optimal combined route, the system may physically link several ride-share network providers. Specifically, a user may wait for a transportation asset (e.g., a car) of a first ride-share network provider at a desired pick-up location and then have another transportation asset (e.g., a bicycle) rented from a second ride-share network provider. The user may start the ride on the transportation asset of the first ride-share network provider for the first portion of the route and use the transportation asset of the second ride-share network provider for the second portion of the route.

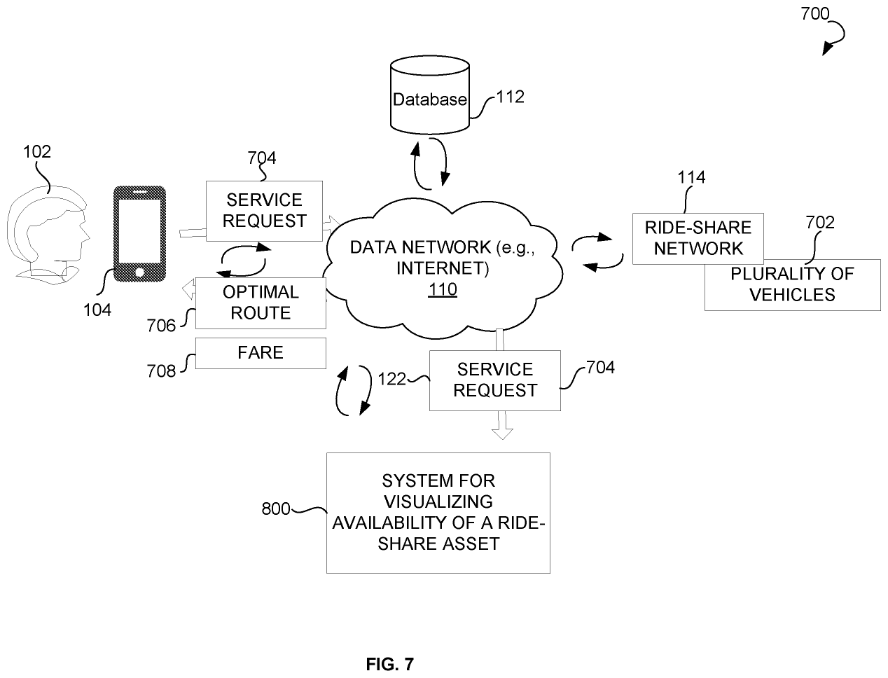

FIG. 7 illustrates an environment 700 within which systems and methods for arranging transportation means can be implemented, in accordance with some embodiments. The environment 700 may include a user 102, a user device 104, a system 700 for arranging transportation means (also referred to as a system 700), a ride-share network 114, a plurality of vehicles 702 associated with the ride-share network 114, a data network 110 (e.g., the Internet or a computing cloud), and a database 112. The user device 104, the system 700, the ride-share network 114, and the plurality of vehicles 702 may be connected via the data network 110.

The ride-share network 114 may include a plurality of vehicles 702, also referred to as transportation assets. The user 102 may send a service request 704, via the user device 104, to rent one of the vehicles 702 of the ride-share network 114. The service request 704 may include a current location of the user device 104, a destination location, and vehicle criteria. The vehicle criteria may specify a combination of a car and an electric mobility device.

The system 700 may then receive the service request 704 and upon receipt of the service request 704, determine current locations of the plurality of vehicles 702 available to provide a transportation means to the user 102. Based at least on the current location of the user device 104 and the current locations of the plurality of vehicles 702 that satisfy the vehicle criteria, the system 700 may select a vehicle from the plurality of vehicles 702. Upon selection of the vehicle, the system 700 may calculate an optimal route 706 from the current location of the user device 104 to the destination location. The optimal route 706 may include a vehicle change point along the optimal route where the user may remove the electric mobility device from the car and use the electric mobility device for the remainder of the optimal route.

The system 700 may further determine a fare 708 for providing the transportation means to the customer and provide data associated with the selected vehicle, the optimal route 706, and the fare 708 to the user device 104.

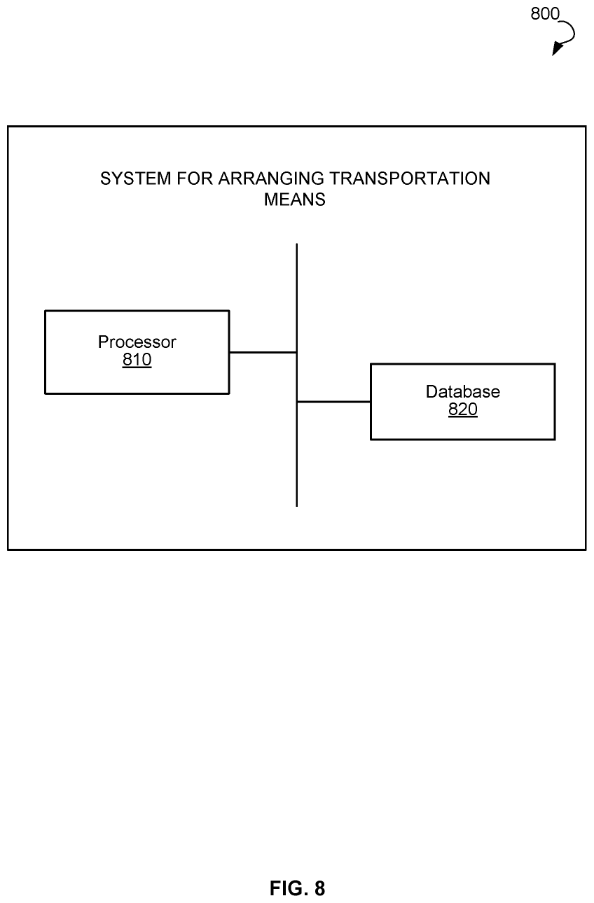

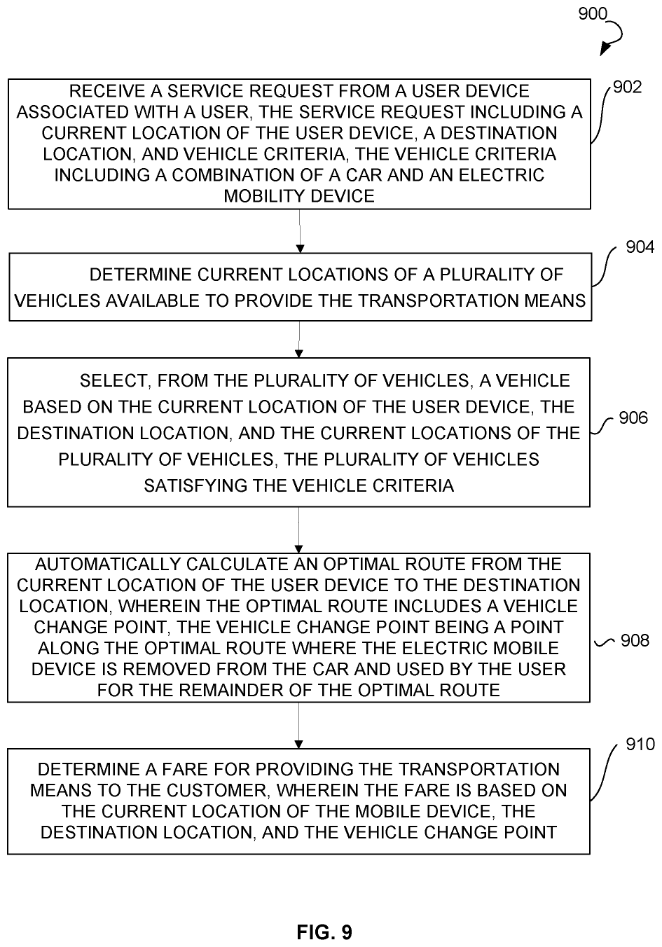

FIG. 8 is a block diagram showing various modules of a system 800 for arranging transportation means, in accordance with certain embodiments. The system 800 may include a processor 810 and a database 820. The database 820 may include computer-readable instructions for execution by the processor 810. The processor 810 may include a programmable processor, such as a microcontroller, CPU, and so forth. In other embodiments, the processor 810 may include an application-specific integrated circuit or programmable logic array, such as a field programmable gate array, designed to implement the functions performed by the system 800. In various embodiments, the system 800 may be installed on a user device or may be provided as a cloud service residing in a cloud storage. The operations performed by the processor 810 and the database 820 are described in detail with reference to FIG. 9.

FIG. 9 is a flow chart illustrating a method 900 for arranging transportation means, in accordance with an example embodiment. In some embodiments, the operations may be combined, performed in parallel, or performed in a different order. The method 900 may also include additional or fewer operations than those illustrated. The method 900 may be performed by processing logic that may comprise hardware (e.g., decision making logic, dedicated logic, programmable logic, and microcode), software (such as software run on a general-purpose computer system or a dedicated machine), or a combination of both.

The method 900 may commence with receiving, by a processor, such as the processor 810 shown on FIG. 8, a service request from a user device associated with a user at operation 902. The service request may include a current location of the user device, a destination location, and vehicle criteria. The vehicle criteria may include a combination of a car and an electric mobility device. The electric mobility device may include one of the following: a bicycle, an electric bicycle, a self-balancing scooter, and the like. The method 900 may further include determining, by the processor, current locations of a plurality of vehicles that comply with the vehicle criteria, i.e. are combination of a car and an electric mobility device, and are available to provide the transportation means at operation 904.

The method 900 may continue with selecting, by the processor, from the plurality of vehicles, a vehicle based at least on the current location of the user device and the current locations of the plurality of vehicles at operation 906. The selected vehicle may satisfy the vehicle criteria, i.e. may be the combination of the car and the electric mobility device.

The method 900 may further include operation 908, at which the processor may automatically calculate an optimal route from the current location of the user device to the destination location. The optimal route may include a vehicle change point. The vehicle change point may be a point along the optimal route where the electric mobility device may be removed from the car and used by the user for the remainder of the optimal route. In some example embodiments, the selection of the vehicle change point may be performed using last mile logistics techniques. Specifically, it may be unreasonable to ride last few miles of the route using the car because of traffic jams that usually occur at the time of the ride. Therefore, the vehicle change point may be selected before the road portion having traffic jams to allow the user to use the electric mobility device to avoid the traffic jams.

The method 900 may further include determining a fare for providing the transportation means to the customer at operation 910. The fare may be based on the current location of the user device, destination location, and vehicle change point.

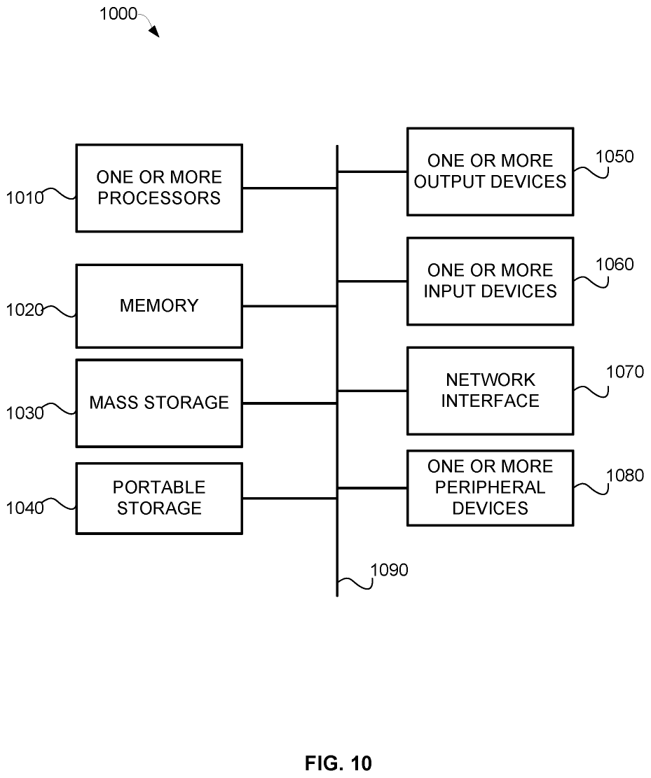

FIG. 10 illustrates an exemplary computing system 1000 that may be used to implement embodiments described herein. The exemplary computing system 1000 of FIG. 10 may include one or more processors 1010 and memory 1020. Memory 1020 may store, in part, instructions and data for execution by the one or more processors 1010. Memory 1020 can store the executable code when the exemplary computing system 1000 is in operation. The exemplary computing system 1000 of FIG. 10 may further include a mass storage 1030, portable storage 1040, one or more output devices 1050, one or more input devices 1060, a network interface 1070, and one or more peripheral devices 1080.

The components shown in FIG. 10 are depicted as being connected via a single bus 1090. The components may be connected through one or more data transport means. The one or more processors 1010 and memory 1020 may be connected via a local microprocessor bus, and the mass storage 1030, one or more peripheral devices 1080, portable storage 1040, and network interface 1070 may be connected via one or more input/output buses.

Mass storage 1030, which may be implemented with a magnetic disk drive or an optical disk drive, is a non-volatile storage device for storing data and instructions for use by a magnetic disk or an optical disk drive, which in turn may be used by one or more processors 1010. Mass storage 1030 can store the system software for implementing embodiments described herein for purposes of loading that software into memory 1020.

Portable storage 1040 may operate in conjunction with a portable non-volatile storage medium, such as a compact disk (CD) or digital video disc (DVD), to input and output data and code to and from the computing system 1000 of FIG. 10. The system software for implementing embodiments described herein may be stored on such a portable medium and input to the computing system 1000 via the portable storage 1040.

One or more input devices 1060 provide a portion of a user interface. The one or more input devices 1060 may include an alphanumeric keypad, such as a keyboard, for inputting alphanumeric and other information, or a pointing device, such as a mouse, a trackball, a stylus, or cursor direction keys. Additionally, the computing system 1000 as shown in FIG. 10 includes one or more output devices 1050. Suitable one or more output devices 1050 include speakers, printers, network interfaces, and monitors.

Network interface 1070 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 1070 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 1080 may include any type of computer support device to add additional functionality to the computing system. The one or more peripheral devices 1080 may include a modem or a router.

The components contained in the exemplary computing system 1000 of FIG. 10 are those typically found in computing systems that may be suitable for use with embodiments described herein and are intended to represent a broad category of such computer components that are well known in the art. Thus, the exemplary computing system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, transportation sharing based payment systems and methods, systems and methods for visualizing availability of ride-share transportation assets, and systems and methods for arranging transportation means are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A transportation sharing based payment system, the system comprising:
a processor configured to:
ascertain a current user of a transportation asset and routing information associated with the transportation asset and the current user;
link a funding source of the current user to a payment platform;
based on the routing information, direct the current user to a merchant location by using an incentive to purchase at least one item at the merchant location;
determine that the transportation asset has arrived at the merchant location;
receive an indication from the current user of an intent to purchase the at least one item associated with the incentive; and
based at least on the indication of the intent to purchase and determination that the transportation asset has arrived at the merchant location, complete a financial transaction associated with a purchase of the at least one item, the financial transaction being completed directly through the payment platform without the use of the funding source; and
a database communicatively coupled to the processor, the database storing instructions executable by the processor.

2. The system of claim 1, wherein the transportation asset includes at least two vehicles, the current user being able to use at least one of the least two vehicles for at least part of a travel to the merchant location.

3. The system of claim 1, wherein the transportation asset includes an electric scooter.

4. The system of claim 3, wherein the electric scooter is a part of a fleet of peer-to-peer ridesharing electrical scooters.

5. The system of claim 1, wherein the routing information includes one or more of the following: a current location of the transportation asset, a current route of the transportation asset, historical routes of the current user, historical routes of a plurality of users, a predicted location of the transportation asset, and a desired destination of the current user.

6. The system of claim 1, wherein the financial transaction is completed by scanning a payment code associated with the incentive on a device associated with the current user at the point of purchase associated with the merchant.

7. The system of claim 6, wherein the payment code is generated and presented to the current user upon arrival at the merchant location.

8. The system of claim 1, wherein the financial transaction is completed by transmitting tokenized credit card information by the transportation asset to the merchant wirelessly via a docking station located within a vicinity of the merchant location.

9. The system of claim 1, wherein the financial transaction is completed automatically upon arrival of the transportation asset at the merchant location.

10. The system of claim 1, wherein the incentive is provided based on a determination that the merchant location is along a predicted route of the transportation asset.

11. A system for visualizing availability of ride-share transportation assets, the system comprising:
a processor configured to:
receive, from a user, a desired pick-up location for a ride-share transportation asset associated with a ride-share network;
automatically calculate a range of acceptable pick-up locations in a vicinity of the desired pick-up location;
ascertain routing information concerning a plurality of ride-share transportation assets, the plurality of ride-share transportation assets being associated with the ride-share network;
predict availability times and destinations for the plurality of ride-share transportation assets based on the routing information; and
for each of the plurality of ride-share transportation assets with a predicted destination within the vicinity of the desired pick-up location at the predicted availability time, visualize, via a user device associated with the user, arrival information for the plurality of ride-share transportation assets, the visualization being indicative of an arrival time for each of the plurality of ride-share transportation assets in the vicinity of the desired pick-up location; and
a database communicatively coupled to the processor, the database storing instructions executable by the processor.

12. The system of claim 11, wherein the ride-share transportation asset includes an electric scooter.

13. The system of claim 11, wherein the routing information includes one or more of the following: a current location, a travel direction, an intended route, a destination, user attributes, historical travel data of the user using the user device, and historical travel data of a plurality of users.

14. The system of claim 13, wherein the historical travel data includes user riding data and locations frequented by the user.

15. The system of claim 11, wherein the predicting of the availability times is based on a current distance of each of the plurality of ride-share transportation assets to the pick-up desired location.

16. The system of claim 11, wherein the routing information is further based on aggregate locations of common public interest destinations.

17. The system of claim 11, wherein the visualization includes one or more of the following: gradually changing colors of icons associated with the plurality of ride-share transportation assets to indicate a predicted time left to the availability of the plurality of ride-share transportation assets, gradually changing colors of icons associated with an accuracy of the predicted destination, and gradually changing colors of icons associated with the distance from the predicted destination to the desired pick-up location.

18. A system for arranging transportation means, the system comprising:
a processor configured to:
receive a service request from a user device associated with a user, the service request including a current location of the user device, a destination location, and vehicle criteria, the vehicle criteria including a combination of a car and an electric mobility device;
determine current locations of a plurality of vehicles available to provide the transportation means;
select, from the plurality of vehicles, a vehicle based at least on the current location of the user device and the current locations of the plurality of vehicles, the plurality of vehicles satisfying the vehicle criteria;
automatically calculate an optimal route from the current location of the user device to the destination location, wherein the optimal route includes a vehicle change point, the vehicle change point being a point along the optimal route where the electric mobility device is removed from the car and used by the user for the remainder of the optimal route; and
determine a fare for providing the transportation means to the customer, wherein the fare is based on the current location of the user device, the destination location, and the vehicle change point; and
a database communicatively coupled to the processor, the database storing instructions executable by the processor.

19. The system of claim 18, wherein the calculating of the optimal route is performed using at least one last mile logistics technique.

20. The system of claim 18, wherein the processor is further configured to visualize, via the user device associated with the user, the optimal route, and the fare, and arrival information associated with the vehicle.
